(19) United States
(12) Patent Application Publication
(10) Pub. No.: US 2017/0028556 A1
(43) Pub. Date: Feb. 2, 2017

(54) PATH-OPTIMIZED MANIPULATOR REVERSING CONTROLLER

(71) Applicant: HARRIS CORPORATION, Melbourne, FL (US)

(72) Inventors: Matthew D. Summer, Melbourne, FL (US); Paul M. Bosscher, West Melbourne, FL (US)

(21) Appl. No.: 14/811,086

(22) Filed: Jul. 28, 2015

(51) Int. Cl. B25J 9/16; B25J 9/06; B25J 5/00

(52) U.S. Cl. CPC B25J 9/1664; B25J 5/00; B25J 9/06; B25J 9/161; B25J 9/1666; Y10S 901/02; Y10S 901/01

(57) ABSTRACT

Systems (100) and methods (1000) for removing a robotic device (100) from a space. The method comprises: periodically recording poses of a Movable Component (“MC”) as it travels through the space; recording connectivity of the poses; using the poses and connectivity to define paths of travel through a virtual multi-dimensional space of a map; analyzing the map to identify pairs of adjacent waypoint data points that are located distances from each other which are less than a threshold; generating an augmented map by adding new connections between waypoint data points of each said pair; selecting an optimal path of travel through a virtual multi-dimensional space of the augmented map from a current pose of MC (106) to a desired pose of MC; and commanding MC to perform a reverse behavior in which the optimal path is traversed in a first direction so as to remove the same from the space.

### FIELD OF THE INVENTION

This document relates generally to Unmanned Ground Vehicles (“UGVs”). More particularly, this document relates to UGVs with a path-optimized manipulator reversing controller.

### BACKGROUND OF THE INVENTION

UGVs are motorized vehicles that operate without an on-board human presence. Remotely-controlled and remotely-guided unmanned vehicles (such as UGVs) are in widespread use in applications such as Explosive Ordinance Disposal (“EOD”), search and rescue operations, hazardous material disposal, surveillance, etc. A typical UGV includes a chassis, wheels, drive motors mounted on the chassis, an articulating arm mounted on top of the chassis, grippers and a camera mounted on the arm. UGVs can also be equipped with steerable front wheels to facilitate directional control. Alternatively, UGVs can include tracks that facilitate operation over rough terrain. Steering of tracked UGVs can be effectuated by simultaneously operating the wheels or tracks on opposite sides of the UGV.

Movement and steering of a UGV can be controlled by a user from a location remote from the UGV using a joystick-equipped control unit. The control unit communicates with the UGV by way of a wireless communication link. The control unit may also be used to remotely control the UGV's robotic arm, gripper, and camera. Movement of the UGV is typically controlled by modulating the velocity of the UGV in proportion to the displacement of the joystick of the control unit.

A robotic arm of a UGVs is often extended into a confined space (e.g., an interior space of a car). Reaching into a confined space is easily achieved using the articulating arm of a UGV since a forward facing camera and/or sensors are disposed on the gripper. However, removing the articulating arm from the confined space is challenging without colliding with the surroundings. Various solutions have been proposed for removing articulating arms from confined spaces.

A first solution involves full manual control of the articulating arm's movements. In this case, an operator attempts to cleanly remove the articulating arm from the confined space. Additional cameras coupled to the articulating arm may aid the operator in his(her) manual control of the articulating arm's movements. Manually removing the articulating arm from the confined space is relatively difficult and slow. The manual removal also often results in collisions of the articulating arm with obstacles present within the confined space.

A second solution involves trying to better understand a surrounding environment. This understanding is achieved by adding three dimensional sensor disposed on the gripper. The three dimensional sensors detect obstacles within the surrounding environment. Notably, the sensors do not differentiate between soft obstacle which could not cause damage to the articulating arm (e.g., a pile of leaves) and hard obstacles which could cause damage to the articulating arm (e.g., a rock). The additional sensor data is used to build a three dimensional model of the surrounding space including any detected obstacles. Thereafter, the three dimensional model is used to plan optimized collision free paths through the confined space. This solution is relatively complex and expensive.

A third solution involves applying a skin of distributed sensors around the articulating arm so that the robot senses contact with objects. However, in some scenarios, it is undesirable for the articulating arm to come in contact with any object in the surrounding space. Also, this solution is relatively expensive and complex.

### SUMMARY OF THE INVENTION

The present disclosure concerns implementing systems and methods for removing a robotic device (e.g., a UGV) from a space (e.g., a car interior space). The method comprises: periodically recording poses of a movable component (e.g., a movable base or an articulating arm) of the robotic device as it travels through a space; recording connectivity of the poses based on a sequence of achieving the poses; using the poses and connectivity to define paths of travel through a virtual multi-dimensional space of a map; analyzing the map to identify pairs of adjacent waypoint data points that are located distances from each other which are less than a pre-defined closeness threshold; generating an augmented map by adding new connections between waypoint data points of each pair of adjacent waypoint data points which was previously identified; selecting an optimal path of travel through a multi-dimensional space of the augmented map from a current pose of the movable component to a desired pose of the movable component; and commanding the movable component to perform a reverse behavior in which the optimal path is traversed in a first direction so as to retract the movable componet from the space. The method may further involve initiating a forward behavior of the movable component in which the optimal path is traversed in a second direction opposed to the first direction.

In some scenarios, the optimal path comprises positions of the movable component as the movable component traveled forward through the space but in a different order or sequence. The optimal path of travel is selected in response to a reception of a user-software interaction with a control unit remote from the robotic device. The optimal path of travel is a shortest or fastest path of a plurality of paths of travel contained in the augmented map. In this regard, the optimal path may be selected based on the recorded speed and/or an age of the poses. The speed of movement along at least a portion of the optimal path is a function of a previously recorded speed of movement of the movable component.

### DESCRIPTION OF THE DRAWINGS

Embodiments will be described with reference to the following drawing figures, in which like numerals represent like items throughout the figures, and in which:

FIG. 1 is a perspective view of an UGV and a control unit.

FIG. 2 is a perspective view of the UGV shown in FIG. 1.

FIG. 3 is an illustration of various electrical and electronic components of the vehicle shown in FIGS. 1-2.

FIG. 4 is an illustration of various electrical and electronic components of the controller shown in FIG. 3.

FIG. 5 is an illustration of various electrical and electronic components of the control unit shown in FIG. 1.

FIGS. 6-7 each provide an illustration of a two dimensional map showing an articulating arm's path of travel through a space in which movement of the articulating arm is restricted due to nearby objects.

FIG. 8 is an illustration of a modified version of the two dimensional map shown in FIG. 6.

FIG. 9 is an illustration of a two dimensional map showing a selected reverse path for removing an articulating arm from a confined space without colliding with objects in a surrounding environment.

FIG. 10 provides a flow diagram of an exemplary method for removing a movable component of a robotic device from a space.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

This disclosure concerns systems and methods for reversing movement of an articulating arm and/or other robotic device (e.g., a robotic vehicle base or humanoid robots) through a space (e.g., an interior of a car) in which movement of the articulating arm is restricted due to the presence of nearby objects. For convenience, such spaces may sometimes be referred to herein as “confined spaces”. These systems and methods provide techniques for operating articulating arms or other robotic devices in confined spaces easier and safer without adding significant cost and/or complexity to the robotic systems.

The methods generally involve: periodically recording poses of a movable component (e.g., a movable base or an articulating arm) of the robotic device as it travels through a space; recording connectivity of the poses based on a sequence of achieving the poses; using the poses and connectivity to define paths of travel through a multi-dimensional space, thereby creating a map; analyzing the map to identify pairs of adjacent waypoint data points that are located distances from each other which are less than a pre-defined closeness threshold; generating an augmented map by adding new connections between waypoint data points of each pair of adjacent waypoint data points which was previously identified; selecting an optimal path of travel through a virtual multi-dimensional space of the augmented map from a current pose of the movable component to a desired pose of the movable component; and commanding the movable component to perform a reverse behavior in which the optimal path is traversed in a first direction so as to retract the movable component from the space. The method may further involve initiating a forward behavior of the movable component in which the optimal path is traversed in a second direction opposed to the first direction.

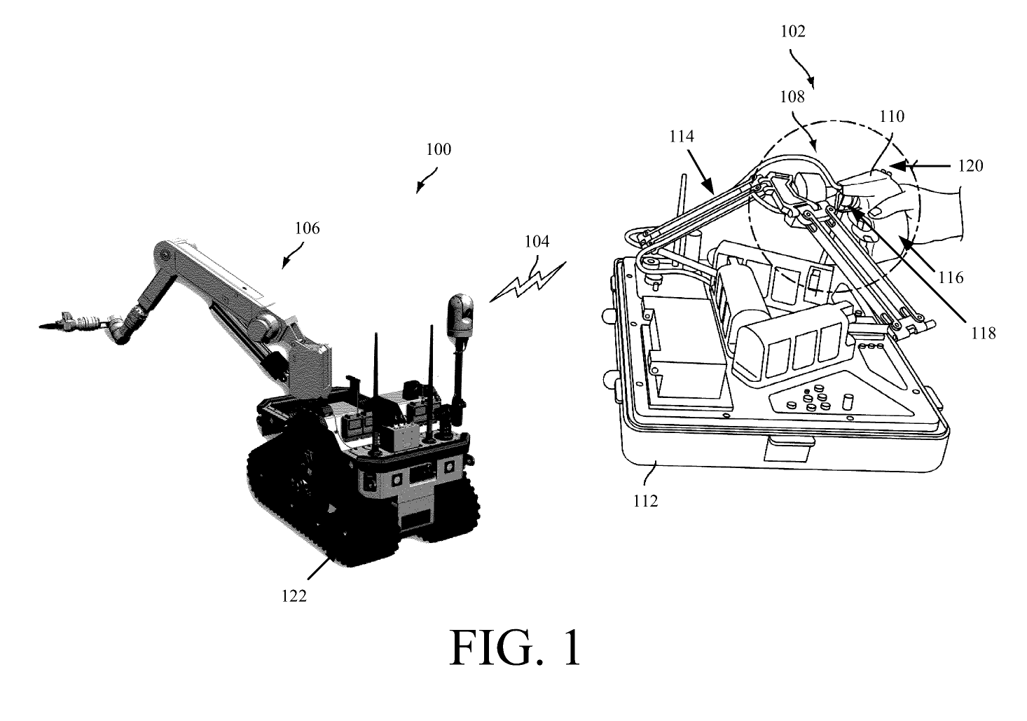

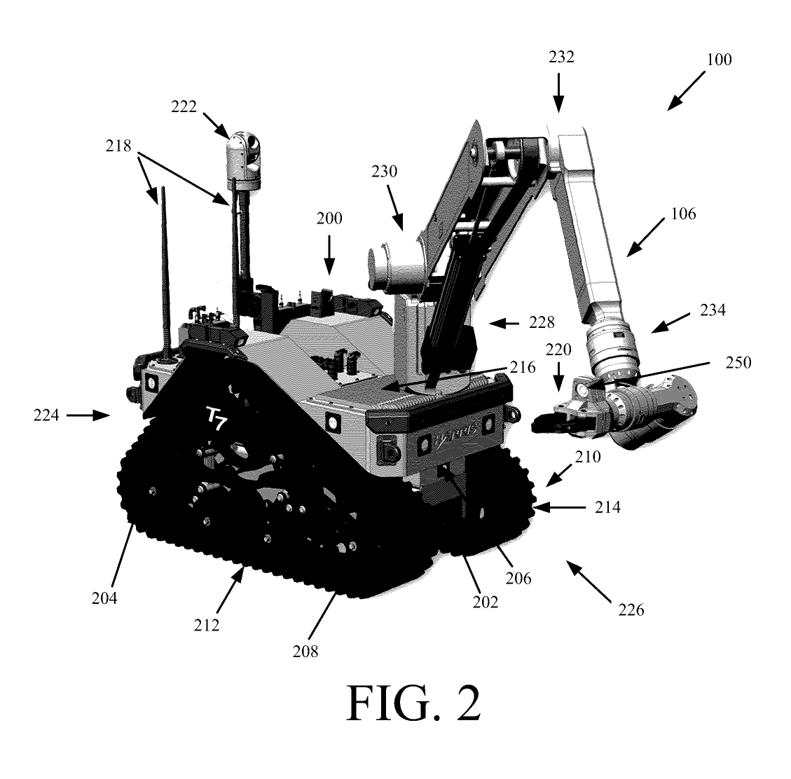

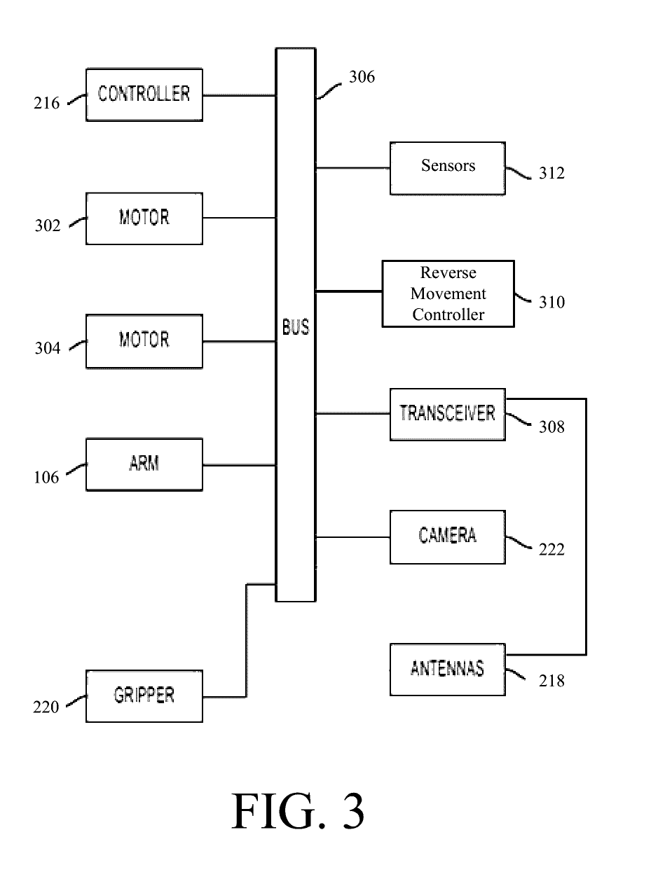

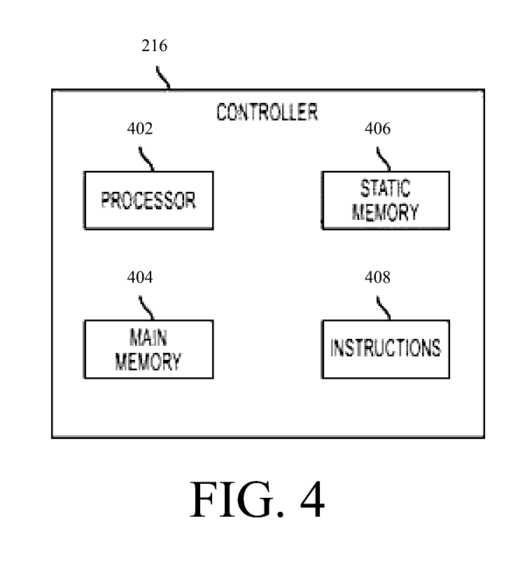

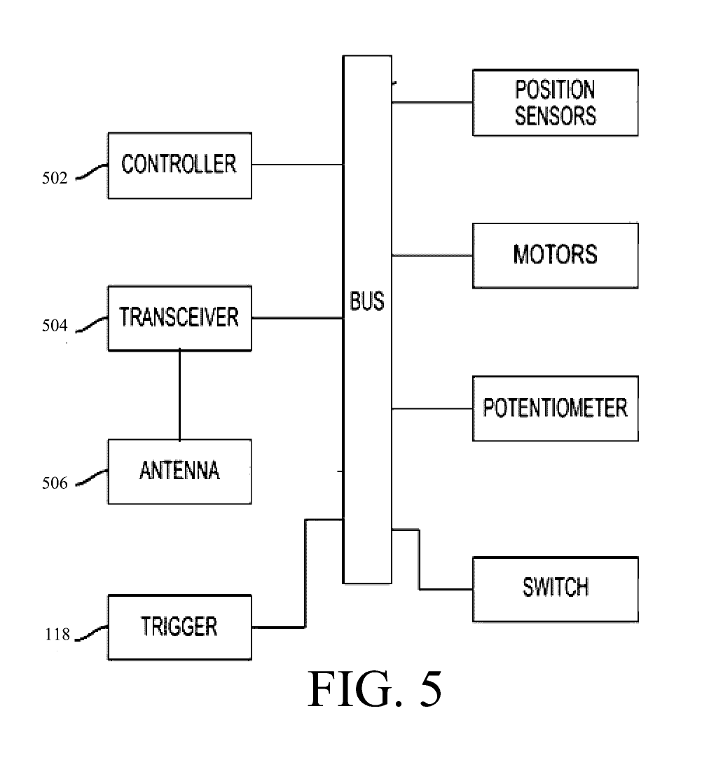

Referring now to FIGS. 1-4, there are provided schematic illustrations of an exemplary UGV 100 and control unit 102. The schematic illustrations of the UGV 100 and control unit 102 shown in FIGS. 1-2 are not drawn to scale. For example, the UGV 100 can be significantly larger than the control unit 102. However, FIGS. 1-2 are sufficient for understanding the present invention, and relationship between the two electronic components 100 and 102.

The UGV 100 is a motorized vehicle that operates without an on-board human presence. The UGV 100 can be used in various applications, such as EOD applications, search and rescue applications, hazardous material disposal applications, and/or surveillance applications. The UGV 100 can be remotely controlled using the control unit 102. In this regard, the control unit 102 enables a user's control of the UGV's operations and movement from a remote location.

The UGV 100 includes a body 200 comprising a rigid chassis 202. The UGV 100 also includes movable elements in the form of two rear wheels 204, 122 and two front wheels 208, 210. The rear wheels 204, 122 are mounted proximate a rear-end 224 of the rigid chassis 202 on opposite sides thereof The front wheels 208, 210 are mounted proximate the front end 226 of the rigid chassis 202 on opposite sides thereof In alternative embodiments, the movable elements can be structures other than wheels, such as articulating legs.

The UGV 100 further comprises actuating devices in the form of two variable-speed, reversible electric motors 302, 304. The motors 302, 304 are mounted on the body 200. The motor 302 is coupled to the front wheel 208 so that activation of the motor 302 causes the front wheel 208 to rotate. The motor 304 is coupled to the front wheel 210 so that activation of the motor 304 causes the front wheel 210 to rotate. Additional motors (not shown) can be employed for directly driving the rear wheels 204, 122.

The rear wheel 204 and the front wheel 208 are located on the same side of the UGV 100. The rear wheel 204 and the front wheel 208 are coupled by way of a tread or track 212. Rotation of the front wheel 208 drives the track 212, which in turn causes the rear wheel 204 to rotate. Similarly, the rear wheel 122 and the front wheel 210 are located on the same side of the UGV 100. The rear wheel 122 and the front wheel 210 are coupled by way of a tread or track 214. Rotation of the front wheel 210 drives the track 214, which in turn causes the rear wheel 122 to rotate.

The UGV 100 further includes a controller 216. The controller 216 comprises a processor 402 (e.g., a Central Processing Unit (“CPU”)), a main memory 404 and a static memory 406. These electronic components 402-406 communicate with each other via a bus 306. The static memory 406 stores one or more sets of instructions 408 (e.g., software code). The instructions 408 implement one or more of the methodologies, procedures, or functions described herein. The instructions 408 can also reside, completely or at least partially, within the main memory 404 or the processor 402 during execution thereof thereby. The main memory 404 and the processor 402 also can constitute machine-readable media.

A reverse movement controller 310 and sensors 312 are provided within the UGV 100. The sensors 312 can include, but are not limited to, inclinometers, Attitude and Heading Reference Sensors (“AHRS”), accelerometers, inertial reference sensors and Global Positioning System (“GPS”) sensors. In some scenarios, outputs from the sensors 312 are used by the reverse movement controller 310 for removing all or a portion of the UGV 100 from confined spaces without colliding with objects in a surrounding environment. This removal is achieved by automatically and dynamically determining a reverse path through a surrounding environment based on previous movements of all or a portion of the UGV 100. Notably, no manual efforts are required by an operator of the UGV to remove all or a portion of the UGV 100 from the confined space, other than initiating automatic operations by the UGV and/or control unit 102 to control reverse movements of all or a portion of the UGV. This initiation can be achieved via a user software interaction with a physical button or a virtual button of the control unit 102.

The UGV 100 includes a transceiver 308 communicatively coupled to the processor 402 via the bus 306. The transceiver 308 communicates with the control unit 102 via a wireless communication link 104 (e.g., a Radio Frequency (“RF”) transmission). One or more antennas 218 (is)are provided to facilitate the transmission and reception of information to and from the transceiver 308 of the UGV 100. In some scenarios, outputs from the sensors 312 are communicated from the UGV 100 to the control unit 102 for use thereby in subsequent reverse movement operations for removing all or a portion of the UGV 100 from confined spaces without colliding with objects in a surrounding environment.

An articulating arm 106 is mounted on the body 200 of the UGV 100. The articulating arm 106 is equipped with at least one gripper 220, which is mounted on the freestanding end thereof One or more cameras 206, 222 is (are) also mounted on the body 200 of the UGV 100. The articulating arm 106, gripper 220 and camera(s) 206, 222 can be remotely controlled via the control unit 102. Notably, another camera 250 is located at the gripper 220 of the robot.

The position of the UGV 100 is controlled through the selective activation and deactivation of the motors 302, 304 in response to control inputs generated by the control unit 102. Linear or straight-line travel of the UGV 100 is effectuated by the simultaneous activation of motors 302, 304 in the same direction and at the same speed so as to drive tracks 212, 214 in the same direction and at the same speed. Turning of the UGV 100 can be achieved by (1) simultaneously activating the motors 302, 304 in opposite directions or in the same direction at different speeds or (2) operating only one of the motors 302, 304.

The control unit 102 comprises a controller 502. The controller 502 can have a similar architecture as controller 216 of the UGV 100. As such, the controller 502 may include a processor (not shown) and memory (not shown) housed in a rigid casing (not shown). Instructions (not shown) may be stored in the memory. The instructions can be implemented as software code configured to implement one or more of the methodologies, procedures, or functions described herein. The processor and memory can constitute machine-readable media. In some scenarios, the instructions cause the controller 502 to control reverse movements of all or a portion of the UGV 100 so as to cause the same to be removed from confined spaces without colliding with objects in a surrounding environment.

The control unit 102 also includes a wireless transceiver 504 communicatively coupled to the controller 502. The transceiver 504 is configured to communicate with the transceiver 308 of the UGV 100 via an RF communication link 104. An antenna 506 is provided to facilitate the transmission and reception of RF signals to and from the control unit 102.

The control unit 102 further comprises an input device 108 for providing user inputs to the controller 502. In some scenarios, the input device 108 comprises a joystick to command the vehicle's movement. In other scenarios, the input device 108 comprises a hand grip 110 movably coupled to a base 112 via a plurality of linkages 114. The hand grip 110 includes a body 116 and a trigger 118. The body 116 is sized and shaped to be grasped by the hand of an operator. The trigger 118 is movable between a rest position and a fully depressed position. In this regard, the trigger 118 is mounted on the body 116 so that the user can pull or depress the trigger using his or her index finger while grasping the hand grip 110. Buttons 120 are disposed on the hand grip 110 for providing a means to control the grippers 220, camera 222 and other operational features of the manipulator arm 106.

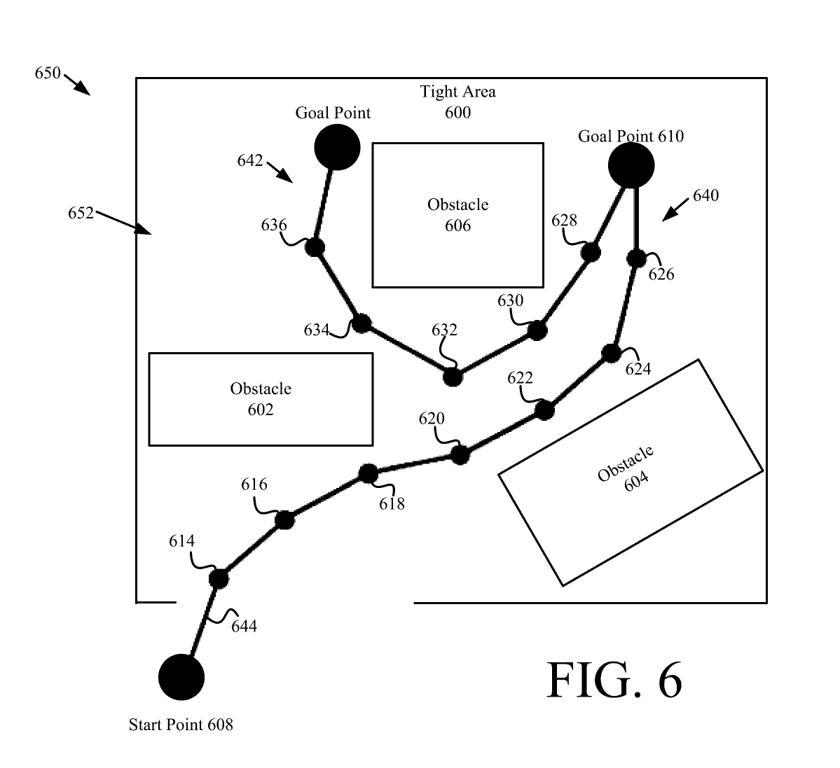

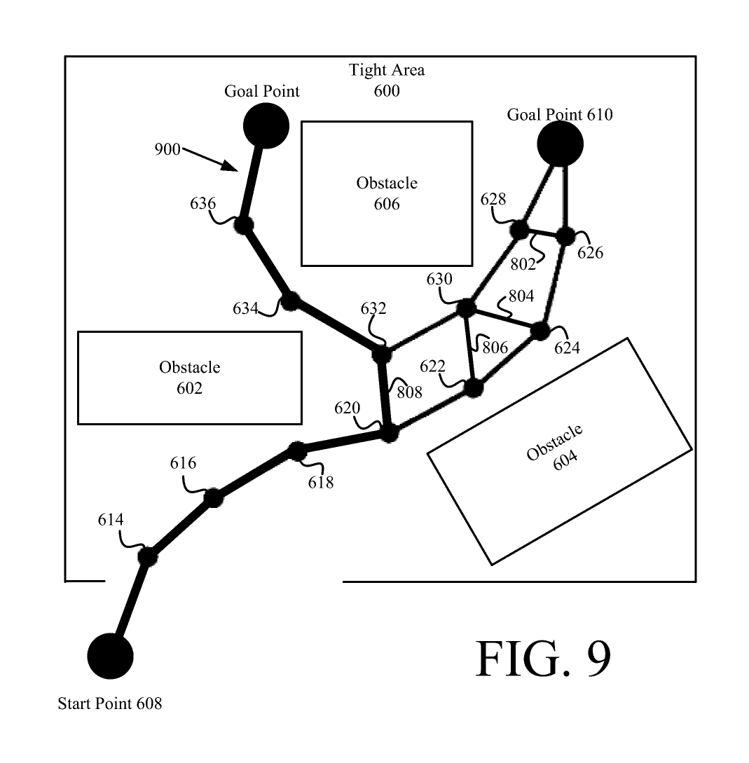

The manner in which all or a portion of the UGV 100 is removed from or reversed through a confined space will now be described in relation to FIGS. 6-9. FIGS. 6-9 are useful for understanding an algorithm implemented by the UGV 100 and/or control unit 102. In this regard, FIG. 6 provides an illustration of a two dimensional map showing an articulating arm's path of travel through a confined space 600 (e.g., a car's interior space). In operation, the coordinate system of the map will likely be more than a two dimensional coordinate system. For example, the articulating arm may have three degrees of freedom. In this case, the map will be a three dimensional map rather than a two dimensional map.

Notably, the UGV 100 comprises a plurality of sensors to indicate the positions of all moveable parts thereof. Accordingly, at least one sensor is provided to indicate the position of each joint of the articulating arm. As such, the joint angles of the joints are known at any given time. Sensors are also provided to indicate movement of the vehicle base of the UGV 100, such as wheel or track movement. The sensors can include, but are not limited to, a dead reckoning module, an inertial measurement unit, and/or a GPS unit.

The algorithm will be described below in relation to the articulating arm. However, the algorithm can be applied to the vehicle base or other movable components of the UGV 100.

As the operator inserts the articulating arm into the tight area 600, the UGV 100 saves waypoint data specifying joint positions and locations within a multi-dimensional space. The term “waypoint”, as used herein, refers to a pose and/or a spatial location of the articulating arm as it moves through the tight area 600. A waypoint may define a stopping place of the articulating arm or a place at which the articulating arm resided while performing a continuous movement. The data specifying joint positions are stored in a data store so as to be associated with data defining waypoint data points, respectively. Time stamps are also obtained and stored in the data store. The time stamps indicate the times at which waypoint data is collected and/or recorded.

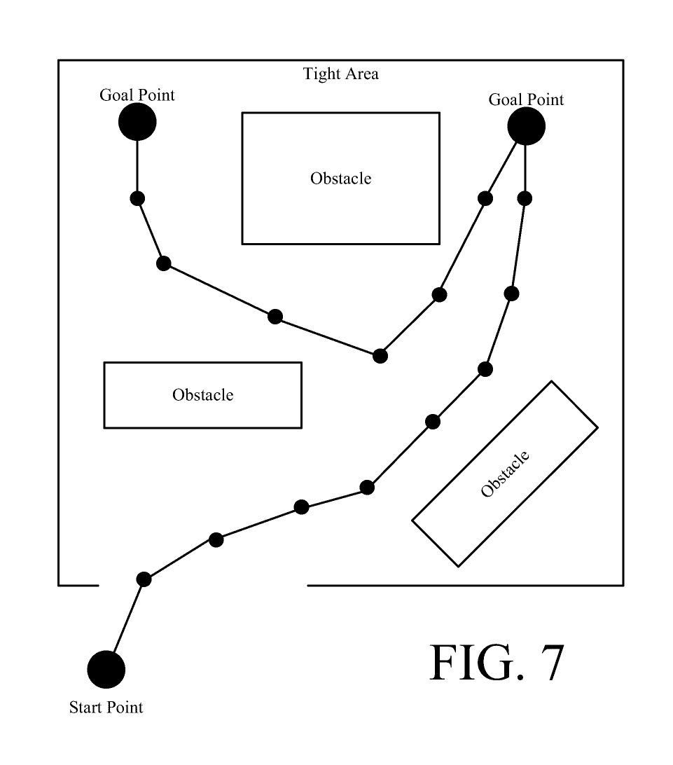

In some scenarios, waypoint data is recorded at intermittent intervals as the articulating arm travels along paths 640, 642. For example, waypoint data is recorded each time the articulating arm has moved beyond a certain threshold displacement from its last recorded position. Alternatively or additionally, waypoint data is recorded at pre-defined times (e.g., every 0.2 seconds). Depending on the speed of the articulating arms, the distance between adjacent waypoint data points can be the same as shown in FIG. 6 or different as shown in FIG. 7.

The waypoint data is used to (a) track movement of the articulating arm through the tight area 600 and/or (b) generate a map showing paths of travel 640, 642 of the articulating arm through the tight area 600. In this regard, a plurality of waypoint data points 616-636 is plotted in the virtual multi-dimensional space 652 of the map 650. Also, connections 644 are made in the map 650 between temporally adjacent waypoint data points based on time stamp information.

An assumption is made that the paths of travel 640, 642 defined by the waypoint data points 614-636 are collision free paths or likely collision free paths with a relatively high degree of confidence, with the robot potentially contacting objects at the end points or goal points of the path (e.g., 610). As such, the paths of travel 640, 642 are subsequently used to determine a reverse path for removing the articulating arm from the tight area 600. If the articulating arm is controlled to follow the exact same path(s) of travel 640 and/or 642 in reverse, then the articulating arm would likely collide with objects and/or other obstacles 602-606 present within the tight area 600 at or near the goal points of the path. For example, if goal point 610 is a glove compartment which was inspected using the gripper of the articulating arm, then the articulating arm would come in contact with the glove compartment when moving along path 640 and/or 642 in reverse. This is undesirable in many applications. Therefore, additional measures are taken herein to ensure that the articulating arm does not exactly follow the path(s) of travel 640 and/or 642 such that re-collision of the articulating arm with objects or other obstacles 602-606 can be prevented and/or avoided.

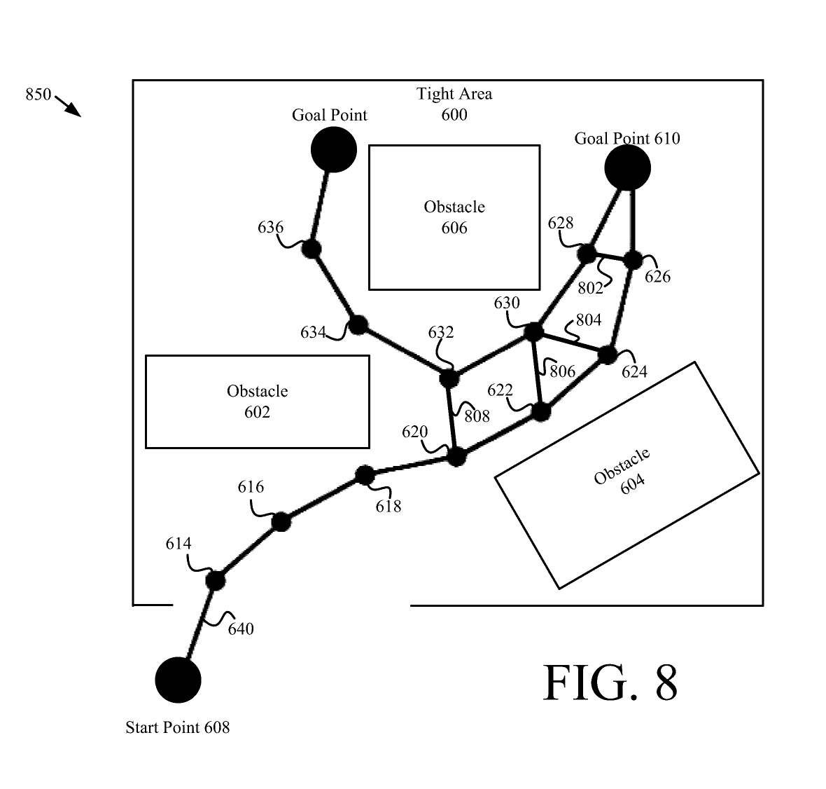

The additional measures will now be discussed in relation to FIG. 8. With reference to FIG. 8, the additional measures involve: analyzing the map 650 to identify pairs of adjacent waypoint data points 620/632, 622/630, 624/630, 626/628 that are located a distance from each other which is less than a pre-defined closeness threshold (e.g., 0.5, feet, 1 foot or 2 feet); and generating an augmented map 850 by adding new connections 802-808 to map 650 between the previously identified waypoint data points. In some scenarios, the pre-defined closeness threshold is selected based on a scale of the articulating arm (or other robotic moveable component) and a scale of the obstacles to be avoided.

The new connections define new paths which can be reversed by the articulating arm for removing the same from the confined space. For example, a new path 900 is selected for reversing the articulating arm through the confined space. New path 900 is defined by waypoint data points 614-620, 632-636. As such, the new path 900 is a better path then that defined by paths 640-642 since it is relatively shorter and/or faster. The new path 900 comprises positions of the articulating arm as it traveled forward through the confined space, but at least partially in a different order or sequence. The articulating arm is then controlled to follow new path 900 in response to a user-software interaction with the control unit 102. The user-software interaction can occur by depressing a physical or virtual button of the control unit 102.

In some scenarios, the new path 900 is selected in response or subsequent to the user-software interaction, rather than prior to the user-software interaction. Also, a rule may be implemented to ensure that new paths are preferred for reversing the articulating arm back through the confined space. In all cases, the articulating arm automatically withdraws upon a reverse path selection without collision with objects or other obstacles 602-606 residing within the confined space.

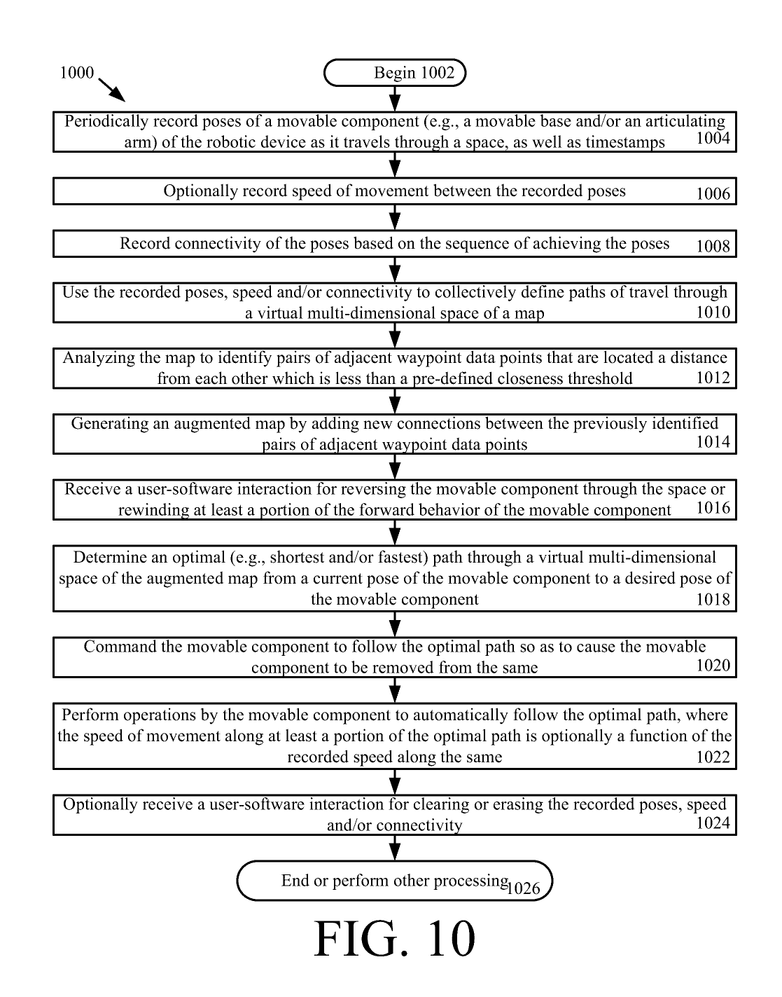

As evident from the above, the systems implementing the algorithm of FIGS. 6-9 include a robotic device (e.g., UGV 100 of FIG. 1) and a control unit (e.g., control unit 102 of FIG. 1). A flow diagram is provided in FIG. 10 which is useful for understanding an exemplary method 1000 of reversing a robotic device through a space. As shown in FIG. 10, method 1000 begins with step 1002 and continues with step 1004 where the pose of a moveable component (e.g., articulating arm 106 of FIG. 1) of the robotic device is periodically recorded. Also, the speed of movement between recorded poses is optionally recorded in step 1006. The connectivity of the poses is recorded in step 1006 based on the sequence of achieving the poses. The recorded poses, speed and/or connectivity are used in step 1010 to collectively define paths of travel through a virtual multi-dimensional space (e.g., space 652 of FIG. 6) to thereby create a map (e.g., map 650 of FIG. 6).

After the map has been generated, it is analyzed in step 1012 to identify pairs of adjacent waypoint data points (e.g., waypoint data points 614-636 of FIG. 6) that are located a distance from each other which is less than a pre-defined closeness threshold. An augmented map (e.g., augmented map 850 of FIG. 8) is generated by adding new connections between the previously identified pairs of adjacent waypoint data points, as shown by step 1014.

In step 1016, a user-software interaction is received for reversing the movable component through the space or rewinding at least a portion of the forward behavior of the movable component. In response to the user-software interaction, an optimal path (e.g., the shortest or fastest path) is determined through the virtual multi-dimensional space of the augmented map from a current pose of the movable component to a desired pose of the movable component, as shown by step 1018. Once the optimal path is selected, step 1020 is performed where the movable component is commanded to follow the optimal path so as to cause the movable component to be removed from the same. In response to the command, the movable component performs operations in step 1022 to automatically follow the optimal path. In some scenarios, the speed of movement along at least a portion of the optimal path is optionally a function of the recorded speed along the same. Next, in optional step 1024, a user-software interaction is received for clearing or erasing the recorded poses, speed and/or connectivity. Thereafter, step 1026 is performed where method 1000 ends or other processing is performed.

There are many advantages to the above-described approach for removing a robotic device from a space. The advantages include, but are not limited to, ease of robotic control in confined spaces and the need for no additional or new sensing functionality. Also, a user is able to initiate a forward behavior of the robotic device to undo any rewinding behavior (i.e., forward movement along the optimal path).

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for removing a robotic device from a space, comprising:
periodically recording poses of a movable component of the robotic device as it travels through a space;
recording connectivity of the poses based on a sequence of achieving the poses;
using the poses and connectivity to define paths of travel through a virtual multi-dimensional space of a map;
analyzing the map to identify pairs of adjacent waypoint data points that are located distances from each other which are less than a pre-defined closeness threshold;
generating an augmented map by adding new connections between waypoint data points of each said pair of adjacent waypoint data points which was previously identified;
selecting an optimal path of travel through a virtual multi-dimensional space of the augmented map from a current pose of the movable component to a desired pose of the movable component; and
commanding the movable component to perform a reverse behavior in which the optimal path is traversed in a first direction so as to retract the movable component from the space.

2. The method according to claim 1, wherein the optimal path of travel is selected in response to a reception of a user-software interaction with a control unit remote from the robotic device.

3. The method according to claim 1, wherein the optimal path of travel is a shortest or fastest path of a plurality of paths of travel contained in the augmented map.

4. The method according to claim 1, wherein the movable component comprises at least one of a movable base or an articulating arm.

5. The method according to claim 1, further comprising initiating a forward behavior of the movable component in which the optimal path is traversed in a second direction opposed to the first direction.

6. The method according to claim 1, wherein a speed of movement along at least a portion of the optimal path is a function of a previously recorded speed of movement of the movable component.

7. The method according to claim 1, wherein the poses are time-stamped.

8. The method according to claim 1, wherein the optimal path is selected based on an age of the poses.

9. The method according to claim 1, wherein the pre-defined closeness threshold is selected based on at least one of a scale of the movable component and a scale of obstacles to be avoided.

10. The method according to claim 1, wherein the optimal path comprises positions of the movable component as the movable component traveled forward through the space but in a different order or sequence.

11. A system, comprising:
an electronic circuit programmed to
periodically record poses of a movable component of a robotic device as it travels through a space,
record connectivity of the poses based on a sequence of achieving the poses,
use the poses and connectivity to define paths of travel through a virtual multi-dimensional space of a map,
analyze the map to identify pairs of adjacent waypoint data points that are located distances from each other which are less than a pre-defined closeness threshold,
generate an augmented map by adding new connections between waypoint data points of each said pair of adjacent waypoint data points which was previously identified,
select an optimal path of travel through a virtual multi-dimensional space of the augmented map from a current pose of the movable component to a desired pose of the movable component, and
command the movable component to perform a reverse behavior in which the optimal path is traversed in a first direction so as to retract the movable component from the space.

12. The system according to claim 11, wherein the optimal path of travel is selected in response to a reception of a user-software interaction with a control unit remote from the robotic device.

13. The system according to claim 11, wherein the optimal path of travel is a shortest or fastest path of a plurality of paths of travel contained in the augmented map.

14. The system according to claim 11, wherein the movable component comprises at least one of a movable base or an articulating arm.

15. The system according to claim 11, wherein the electronic circuit is further configured to initiate a forward behavior of the movable component in which the optimal path is traversed in a second direction opposed to the first direction.

16. The system according to claim 11, wherein a speed of movement along at least a portion of the optimal path is a function of a previously recorded speed of movement of the movable component.

17. The system according to claim 11, wherein the poses are time-stamped.

18. The system according to claim 11, wherein the optimal path is selected based on an age of the poses.

19. The system according to claim 11, wherein the pre-defined closeness threshold is selected based on at least one of a scale of the movable component and a scale of obstacles to be avoided.

20. The system according to claim 11, wherein the optimal path comprises positions of the movable component as the movable component traveled forward through the space but in a different order or sequence.
